(19) United States
(12) Patent Application Publication
(10) Pub. No.: US 2023/0392021 A1
(43) Pub. Date: Dec. 7, 2023

(54) REACTIVE COLD-APPLIED THERMOPLASTIC BOND COAT

(71) Applicant: GCP Applied Technologies Inc., Wilmington, MA (US)

(72) Inventors: Abbas Kazmi, Manchester (GB); Steven Horton, Worsley, Manchester (GB); Katie McGuire, Audenshaw, Manchester (GB); Jonathon Millner, New Mills, High Peak (GB)

(21) Appl. No.: 18/026,545

(22) PCT Filed: Sep. 14, 2021
(86) PCT No.: PCT/US2021/050145

§ 371 Date: Mar. 15, 2023

Related U.S. Application Data
(60) Provisional application No. 63/080,175, filed on Sep. 18, 2020.

(51) Int. Cl. C09D 4/06; C09D 5/02; C09D 5/00; C09D 7/65; C09D 7/63; C09D 133/12; E01C 19/46

(52) U.S. Cl. CPC C09D 4/06; C09D 5/021; C09D 5/002; E01C 19/46; C09D 7/63; C09D 133/12; C09D 7/65

(57) ABSTRACT

Disclosed herein is a reactive cold-applied thermoplastic bond coat system and method of application thereof. The system is a two- or three-component system defined by acrylate-based component(s) and an initiator suspension. Upon mixing of the components at the jobsite, the mixture is applied onto a substrate (e.g., waterproofing membrane), and a pavement material (e.g., asphalt) is applied onto the bond coat. Excellent asphalt compaction was observed, resulting in high surface contact area, along with very low water penetration to the bond coat interface. The high surface contact area and penetration of the asphalt into the bond coat provides a good bond between the asphalt and substrate.

### FIELD OF THE INVENTION

The invention relates to the field of bond coats, and more particularly to thermoplastic bond coats that are cold-applied and reactive, especially in bridge deck waterproofing applications.

### BACKGROUND OF THE INVENTION

Bond coats are known and can be an essential component of a waterproofing system. See FIG. 1. Their primary purpose is to provide adhesion and to aid in compaction of the asphalt/concrete pavement to the waterproofing membrane. Types of bond coats include bitumen based hot melts, solvent-based acrylic bond coats, bitumen emulsions, and cold-applied reactive bond coats. A key property of any bond coat is to display thermoplastic properties; bond coats must melt when heat activated (by application of asphalt onto them at ˜100-180° C.) to form a strong adhesive bond with the pavement material. Conventional cold applied reactive materials do not melt if heated to typical asphalt application temperatures (or higher).

Hot Melt Bitumen Based Materials.

These types of bond coats are primarily comprised of bitumen or polymer-modified bitumen (PMB), which is supplied in solid form at room temperature. On site, the bitumen is melted at high temperatures (˜120-190° C.) using boilers, and the molten material is then applied onto the waterproofing membrane. This is an undesired process due to the high energy requirements on site, risks associated with manually handling molten liquids, and potentially toxic fumes emitted during application. In addition, such bitumen-based materials often display poor adhesion to typical membranes—especially polyurethane and polyurea—and such membranes must be fully over-scattered with aggregate to provide a key between membrane and bitumen bond coat to enable suitable adhesion. Furthermore, PMBs have been observed to de-bond from membranes at high ambient temperatures, resulting in “pick-up” on the wheels, tracks, or tires of the paver/delivery vehicles. Importantly, when testing for adhesion between membrane and asphalt at high temperatures (>30° C.), it is found that the bitumen softens, resulting in poor adhesion values.

Solvent-Based Acrylic Bond Coats.

Solvent-based acrylic bond coats generally are only suitable for use with bitumen-rich, low voids content asphalts, e.g., mastic asphalt or sand carpet. Such bond coats typically contain a high concentration (>50%) of hazardous solvents, which flash off when applied onto the waterproofing membrane, leaving behind a thin film of dry thermoplastic material. The restriction of low wet (and hence dry) coat-weight results in poor all-round performance with many asphalt mix designs, especially those having low bitumen and higher voids content. Further problems can arise if any solvent remains trapped in the coating, which can lead to softening of the asphalt and blistering.

Bitumen Emulsions.

Bitumen emulsions are stabilized dispersions of bitumen in water allowing application at ambient temperature (although many are still heated to ˜80° C.). Application is restricted by ambient temperatures (5° C. and rising). Long dry times are observed, especially at low ambient temperatures and high humidity (>70%). Generally, only low coat weights of dry material are possible (<0.3 kg/m 2). The restriction of low dry coat-weight results in poor all-round performance with many asphalt mix designs, especially those with low bitumen and higher voids content.

Cold-Applied Reactive Bond Coats.

As the name suggests, these materials can be applied at ambient temperatures, eliminating the issues described above associated with having to heat and apply molten materials. Cold-applied reactive bond coats comprise solvent-free liquid resins that are catalyzed immediately prior to application and cure in-situ to form solid coatings. To date, the inventors are aware of only one such product that has been commercialized, i.e., under the brand name BOND COAT 3 sold by the current applicant GCP APPLIED TECHNOLOGIES INC. However, improved adhesion properties and superior thermoplastic properties are desired. Despite excellent performance with some asphalts, a more robust solution is required to provide better bond coat performance on a wider range of asphalt mix designs.

Accordingly, what are needed are superior reactive cold-applied thermoplastic materials that can be used across a wide range of pavement types (e.g., asphalt mix designs), providing strong adhesion and aiding in compaction of the pavement to the waterproofing membrane. Indeed, the importance of sufficient bond strength and avoidance of interconnecting voids at the interface is emphasized in the Highways England Design Manual for Roads and Bridges (Document CD358, Sections 6.4, 8.8, 8.8.1). However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for improved compositions and methodologies for a cold-applied, truly thermoplastic bond coat is now met by a new, useful, and nonobvious invention.

Exemplary embodiments of the current invention are compositions and methods for a 100% solids reactive, cold-applied bond coat that exhibits truly thermoplastic properties after curing. The bond coat comprises an acrylate-based first component, including a tackifier, a plasticizer, and an accelerator; a second component including an initiator suspension; and optionally an acrylate-based third component, including a tackifier and a plasticizer. In certain embodiments, the bond coat cures in a short time to form a solid coating, which in turn melts upon exposure to temperatures exceeding its melting point. Molten bond coats facilitate asphalt compaction at the membrane interface, which in turn increases surface contact area between asphalt and membrane. It also allows aggregate from the asphalt to penetrate into the bond coat layer. Greater surface contact area means greater bonded surface area, resulting in higher tensile and shear adhesion values. Greater surface contact area corresponds to less voids at the membrane interface, restricting the areas where water can penetrate to the interface via interconnecting voids.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawing, in which:

FIG. 1 is a cross-sectional schematic of a bridge deck waterproofing construction, including a substrate, primer, waterproofing membrane(s), bond coat, and pavement surfacing. This schematic is not drawn to scale (e.g., the waterproofing membrane is typically far thicker than the primer).

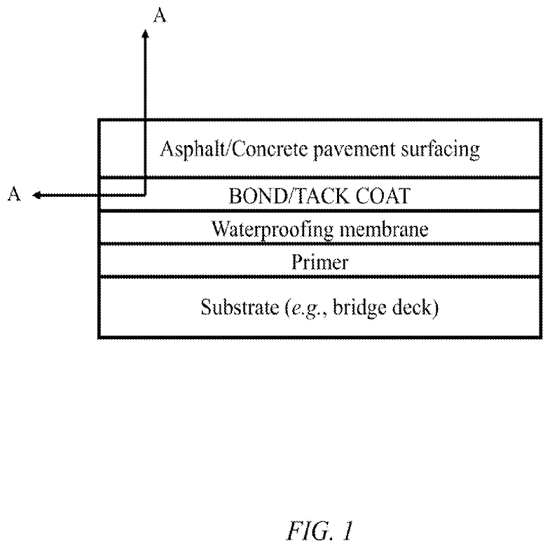

FIG. 2A is a cross-sectional schematic of pavement surfacing (e.g., asphalt) applied on a conventional (non-PMB based) bond coat, where low compaction can be observed at the interface between the bond coat and the pavement surfacing. The voids at the interface lead to low contact area between the asphalt and the bond coat. Water can penetrate and collect in voids in the asphalt. If the voids at the interface are interconnecting, hydrostatic pressure can lead to premature pavement failure.

FIG. 2B is a cross-sectional schematic of pavement surfacing (e.g., asphalt) applied on a bond coat, according to certain embodiments of the current invention, where high compaction and no voids can be observed at the interface between the bond coat and the pavement surfacing. Furthermore, it can be seen that the asphalt penetrates the molten bond coat which is displaced to further fill voids at the interface.

FIG. 3 is a graphical illustration comparing viscosity (at various temperatures) of a polymer-modified bitumen-based thermoplastic bond coat (SA1030) and an embodiment of the current reactive thermoplastic bond coat (BC4). The viscosity is measured by placing material on a heated metal base (e.g., Peltier plate), and a parallel plate is moved down onto the material (1000-μm gap between base and plate). The device measures the viscosity of the material by rotating the parallel plate at a particular shear rate (1 rotation/second) and measuring the resistance.

FIG. 4 is a series of schematics illustrating percent water penetration through asphalt compacted over a bond coat, at the following levels: less than about 1% water penetration, about 50% water penetration, and about 100%. Water penetration and surface contact area between the asphalt and bond coat have an indirect relationship, such that higher surface contact area leads to lower water penetration.

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means±15% of the numerical. In exemplary embodiments, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

In a first example embodiment, the current invention is a reactive cold-applied thermoplastic bond coat system, comprising:
a first component comprising:
   a polyacrylate (e.g., poly(methyl methacrylate) (PMMA)) polymer, preferably in an amount of about 10-30% by weight of the composition,
   acrylate monomers, preferably in an amount of about 5-45% by weight of the composition,
   a tackifier, preferably in an amount of about 10-50% by weight of the composition,
   a plasticizer, preferably in an amount of about 0.1-10% by weight of the composition, and
   an accelerator, preferably in an amount of about 0-5% by weight of the composition;
a second component comprising an initiator suspension, such as a peroxide initiator suspension, in an amount of about 0-10% by weight of the composition; and
optionally a third component comprising:
   a polyacrylate (e.g., PMMA) polymer, preferably in an amount of about 10-30% by weight of the composition;
   acrylate monomers, preferably in an amount of about 5-45% by weight of the composition;
   a tackifier, preferably in an amount of about 10-50% by weight of the composition; and
   a plasticizer, preferably in an amount of about 0.1-10% by weight of the composition;
wherein a mixture of the first component, the second component, and the optional third component is sprayable and cures to form a solid coating.

In a second example embodiment, which may be based on the first example embodiment above, the first component further comprises at least one additive, preferably in an amount of about 0-50% by weight of the composition. In an aspect of this second example embodiment, the at least one additive may be selected from fillers, inhibitors, pigments, anti-settlement aids, rheology modifiers, photoinitiators, UV stabilizers, degassers, antistatic agents, accelerants, catalysts, stabilizers, fire retardants, pH adjusters, reinforcing agents, thickening or thinning agents, elastic compounds, chain transfer agents, radiation absorbing compounds, radiation reflecting compounds, and combinations thereof.

In a third example embodiment, which may be based on any of the first through second example embodiments above, the second component is mixed with the third component (in scenarios when the third component is included) to form an activated third component, where a mixture of the first component and this activated third component is sprayable and cures to form the bond coating. In an aspect of this this third example embodiment, the third component further comprises at least one additive, preferably in an amount of about 0-50% by weight of the composition. Optionally, the at least one additive is selected from fillers, inhibitors, pigments, anti-settlement aids, rheology modifiers, photoinitiators, UV stabilizers, degassers, antistatic agents, accelerants, catalysts, stabilizers, fire retardants, pH adjusters, reinforcing agents, thickening or thinning agents, elastic compounds, chain transfer agents, radiation absorbing compounds, radiation reflecting compounds, and combinations thereof.

In a fourth example embodiment, which may be based on any of the first through third example embodiments above, the bond coat—after curing and upon exposure to a temperature of about 200° C. or below—becomes a molten liquid having a viscosity effective to assist in compaction of a pavement material applied on the bond coat, such that a water penetration at the interface of the bond coat and the pavement material is about 50% or less, preferably about 1% or less. In an aspect of this fourth example embodiment, the exposure temperature is about 100° C. or less and the viscosity is about 6000 cP or less.

In a fifth example embodiment, which may be based on any of the first through fourth example embodiments above, the bond coat results in a shear adhesion between a substrate (e.g., waterproofing membrane) on which the bond coat is applied and a pavement material applied on the bond coat between about 0.3 MPa and about 3.0 MPa at a temperature of about 23° C. and a coat weight of about 600-1200 gsm.

In a sixth example embodiment, which may be based on any of the first through fifth example embodiments above, the bond coat results in a tensile adhesion between the substrate and the pavement material between about 0.3 MPa and about 1.3 MPa at a temperature of about 23° C. and a coat weight of about 600-1200 gsm.

In a seventh embodiment, which may be based on any of the first through sixth embodiments, the current invention is a method of attaching a pavement material to a substrate, comprising:
mixing together a first component and a second component;
wherein the first component comprises:
   a polyacrylate (e.g., PMMA) polymer, preferably in an amount of about 10-30% by weight of the composition,
   acrylate monomers, preferably in an amount of about 5-45% by weight of the composition,
   a tackifier, preferably in an amount of about 10-50% by weight of the composition,
   a plasticizer, preferably in an amount of about 0.1-10% by weight of the composition, and
   an accelerator, preferably in an amount of about 0-5% by weight of the composition;
wherein the second component comprises an initiator suspension, such as a peroxide initiator suspension, in an amount of about 0-10% by weight of the composition;
applying the mixture onto the substrate without the use of heating elements;
allowing the mixture to cure to form a cured bond coat;
applying the pavement material onto the cured bond coat to form a composite of the pavement material, the bond coat, and the membrane (substrate).

In an eighth embodiment, which may be based on any of the fifth through seventh embodiments, the pavement material is asphalt. In an aspect of this eighth embodiment, the asphalt may be selected from asphaltic concrete, hot rolled asphalt, stone mastic asphalt, mastic asphalt, porous asphalt, sand carpet, asphalt protection layer, or a combination thereof. In another aspect of this eighth embodiment, the asphalt may have an average aggregate size of up to about 55 mm.

In a ninth embodiment, which may be based on any of the seventh through eighth embodiments, the substrate is a waterproofing membrane.

In a tenth embodiment, which may be based on any of the seventh through ninth embodiments, the step of applying the mixture onto the substrate is performed by spraying the mixture onto the substrate.

In an eleventh embodiment, which may be based on any of the seventh through tenth embodiments, the mixture is applied onto the substrate at a coat weight of about 100 gsm to about 1400 gsm.

In a twelfth embodiment, which may be based on any of the first through eleventh embodiments, the method further comprises mixing a third component together with the second component to form an activated third component, which is subsequently mixed with the first component and applied onto the substrate.

In a thirteenth embodiment, which may be based on any of the fifth through twelfth embodiments, upon application of the pavement material onto the cured bond coat, the pavement material is capable of compacting on the bond coat, such that a water penetration at the interface of the bond coat and the pavement material is about 50% or less, preferably about 1% or less.

In a fourteenth example embodiment, which may be based on any of the seventh through thirteenth example embodiments above, the bond coat—after curing and upon exposure to a temperature of about 200° C. or below—becomes a molten liquid having a viscosity effective to assist in compaction of a pavement material applied on the bond coat, such that a water penetration at the interface of the bond coat and the pavement material is about 50% or less, preferably about 1% or less. In an aspect of this fourteenth example embodiment, the exposure temperature is about 100° C. or less and the viscosity is about 6000 cP or less.

In a fifteenth example embodiment, which may be based on any of the seventh through fourteenth example embodiments above, the bond coat results in a shear adhesion between the substrate and the pavement material between about 0.3 MPa and about 3.0 MPa at a temperature of about 23° C. and a coat weight of about 600-1200 gsm.

In a sixteenth example embodiment, which may be based on any of the seventh through fifteenth example embodiments above, the bond coat results in a tensile adhesion between the substrate and the pavement material between about 0.3 MPa and about 1.3 MPa at a temperature of about 23° C. and a coat weight of about 600-1200 gsm.

In a seventeenth example embodiment, the current invention is a reactive cold-applied thermoplastic bond coat system based on any one or more—or even all—of the first through sixth example embodiments.

In an eighteenth example embodiment, the current invention is a method of attaching a pavement material to a substrate based on any one or more—or even all—of the seventh through sixteenth example embodiments.

In certain exemplary embodiments, the present invention teaches a liquid composition that has superior thermoplastic properties and can be spray applied to various coat weights depending on the type of asphalt being employed. The resin has a wide application temperature range and can be cold applied using a standard 1:1 ratio pump. Once applied, the system cures seamlessly providing strong adhesion to the waterproofing membrane. Upon application of hot asphalt, the cured bond coat melts becoming highly fluid, facilitating greater compaction of the asphalt at the membrane interface. This results in higher surface contact area between asphalt and membrane, along with reduced air voids at the interface. The system has a cure time within two (2) hours, and preferably one (1) hour, from −10 to 50° C., is a 100% solids reactive system, and has low volatile organic content (VOC). Tensile and shear adhesion values of asphalt to membrane were found to be surprisingly excellent, even when tested at high temperatures (50° C.). In certain embodiments, the composition is particularly useful with waterproofing membranes and can be applied under normal conditions experienced on concrete and steel bridge decks.

Within the context of the present disclosure, the term “cold-applied” refers to the ability of a composition to be applied at ambient temperature without use of boilers for melting or heated lines prior to application. The use of boilers or other heating means is undesirable due to the high energy requirements on site, the risks associated with manual handling of molten liquids and the potentially toxic fumes emitted during application. In contrast, embodiments of the current bond coat composition can be applied at a range of ambient temperatures (e.g., about −10° C. to about 50° C.) without any requirement for heating.

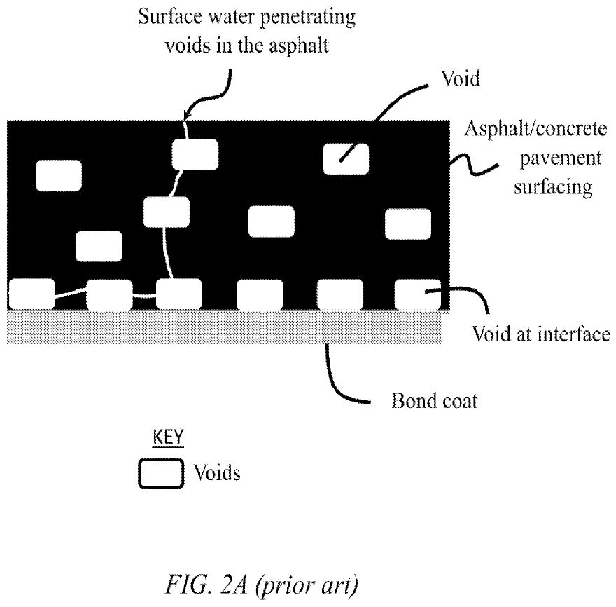

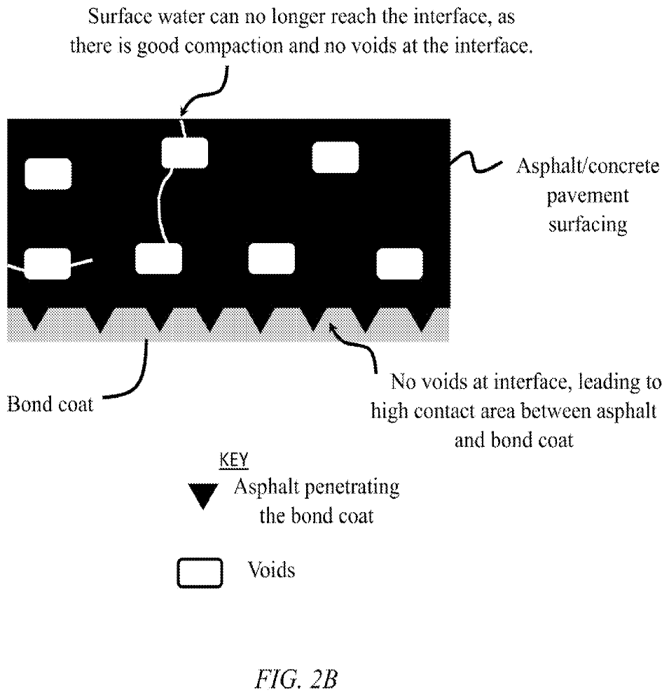

Within the context of the present disclosure, the term “compaction” refers to the process of densifying a hot mix asphalt by reducing voids within the asphalt, thus promoting higher surface contact area between the pavement material and the waterproofing membrane. Good compaction is characterized by lower water penetration to the interface, due to the lack of interconnecting voids within the asphalt. Asphalt mixes are designed to have varying levels of voids following suitable compaction. This typically varies anywhere between about 1% (e.g., mastic asphalt) to about 20% (e.g., porous asphalt). Compaction is typically accomplished by an external force (roller) being exerted on the asphalt mix. Good compaction is often most difficult to achieve at the base of the asphalt layer where it contacts the solid substrate below. The importance of minimizing/eliminating air voids at the interface is a well-documented requirement for minimizing the risk of premature failure of asphalt pavements. Highways England Design Manual for Roads and Bridges (Document CD358) offers guidance on the type and thickness of asphalt to be used directly over the waterproofing membrane. CD358 states that the air void content in the asphalt layer directly above the waterproofing membrane should be below 4% so the amount of water entering the layer is low. It further states that the voids at the base of the asphalt layer shall be prevented from interconnecting—which can be achieved with use of a suitable bond coat. It is contemplated herein that embodiments of the current bond coat achieve better compaction at the interface compared to conventional bond coats (non-PMB based) due to the thermoplastic nature of the current composition. Fully molten bond coats facilitate markedly better compaction compared to conventional cold-applied reactive bond coats. Better compaction at the interface results in more surface contact area between the asphalt and bond coat, which in turn results in greater adhesion. Furthermore, the current bond coat allows the asphalt to penetrate into and embed in the bond coat, creating a strong mechanical bond. At the same time, the molten bond coat is displaced upwards to fill any remaining voids at the interface. See FIGS. 2A-2B for a comparison of low compaction (as seen in conventional non-PMB bond coats) versus high compaction (as seen in the current bond coat).

Within the context of the present disclosure, the term “thermoplastic” refers to a material property in which the material melts when heated to above its melt temperature and solidifies when cooled below its melt temperature. Thermoplastic materials are in contrast to thermoset materials, which are irreversibly solid after curing. Certain embodiments of the current invention are unique in that they are cold applied, liquid materials that cure to become a solid and behave thereafter as a truly thermoplastic material, i.e., becoming molten when heated to above the melt temperature.

Conventionally, cured methyl methacrylate-based cold-applied reactive coatings do not melt when subjected to high temperatures. As such, it was surprising when embodiments of the current invention (an acrylate-based cold-applied reactive material) were found to have truly thermoplastic properties at higher temperatures. Without being bound by theory, it is hypothesized that this phenomenon is occurring due to the combination of a rosin ester and plasticizer being included within the composition and/or due to the plasticizer having lubricating properties at the molecular level, thus allowing a lower density polymer network and/or allowing the polymer network to unwind considerably and become a molten liquid at high temperatures.

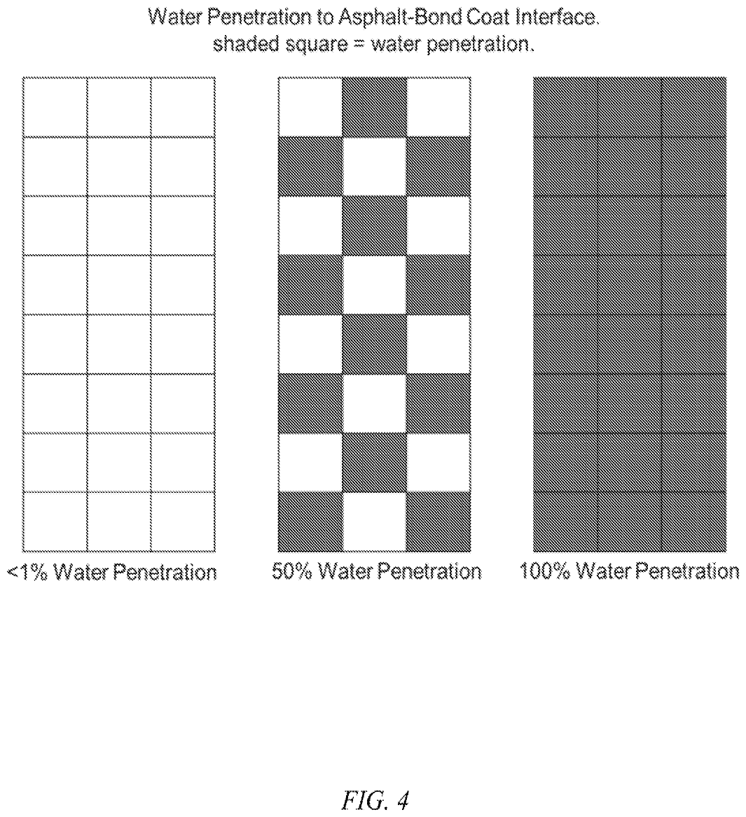

Within the context of the present disclosure, the term “water penetration” refers to the ability of water to permeate across an asphalt mix at the asphalt-membrane interface via interconnecting voids. Water penetration at the interface is recorded herein as a percentage and may be determined by methods known in the art. Within the context of the present disclosure, measurements of water penetration at the interface are acquired according to the following methodology. A full composite sample (i.e., about 1 ft×1 ft) is prepared, including the following layers: concrete, primer, membrane, bond coat, and asphalt. Once the sample is prepared, a concrete saw with a water pump (containing suitably dyed water) is used to cut the sample into test sample sizes (i.e., about 100 mm×200 mm). The water is applied directly on the rotating saw where the cut is taking place. If there are any voids/non-contact areas between asphalt and membrane at the interface, the pressurized water will infiltrate such gaps and traverse the interface via interconnecting voids. After the asphalt layer is removed via a shear adhesion test (according to ETAG 033), the surface of the bond coat can be assessed to determine if water has penetrated through any voids at the asphalt membrane interface. This is a visual assessment in which the approximate surface area contaminated by dyed water at the interface is reported. This is exemplified in FIG. 4, where water penetration is categorized as about 100%, about 50%, or equal to or less than about 1%. Preferably, use of the bond coat according to the present disclosure in the composite system discussed herein results in a water penetration of about 90% or less, preferably about 50% or less, or even more preferably about 1% or less.

Thermoplastic bond coats allow more efficient compaction of the asphalt, minimizing voids at the interface. They can also flow into and fill such voids, further minimizing water ingress down to the membrane interface. In an embodiment, the current invention is a reactive cold-applied thermoplastic bond coat composition that comprises three components (A, B, C) that are mixed and spray applied on site, as follows:
(1) Component A
   a. polyacrylate polymer, preferably in an amount of about 10-30% by weight of the composition;
   b. Acrylate monomers, preferably in an amount of about 5-45% by weight of the composition;
   c. Tackifier, preferably in an amount of about 10-50% by weight of the composition;
   d. Plasticizer, preferably in an amount of about 0.1-10% by weight of the composition;
   e. Optionally at least one additive, preferably in an amount of about 0-50% by weight of the composition; and
   f. An accelerator, preferably in an amount of about 0-5% by weight of the composition.
(2) Component B
   a. An initiator suspension, such as a peroxide initiator suspension, preferably in an amount of about 0-10% by weight of the composition.
(3) Component C
   a. polyacrylate polymer, preferably in an amount of about 10-30% by weight of the composition;
   b. Acrylate monomers, preferably in an amount of about 5-45% by weight of the composition;
   c. Tackifier, preferably in an amount of about 10-50% by weight of the composition;
   d. Plasticizer, preferably in an amount of about 0.1-10% by weight of the composition; and
   e. Optionally at least one additive in an amount of about 0-50% by weight of the composition.

Within the context of the present disclosure, the term “polyacrylate” refers to a synthetic resin formed from the polymerization of acrylic esters, where the resin serves as the polymer backbone of the respective component. Polyacrylate-based plastics are generally characterized by their toughness and elasticity. Examples of polyacrylate polymers that are contemplated to be used herein include, but are not limited to, poly methacrylate polymers (e.g., poly(methyl methacrylate) (PMMA) or poly methyl-co-nbutyl methacrylate). It is contemplated herein that the polyacrylate polymers used herein may be synthesized from a variety of acrylates or methacrylates and can be homopolymers or copolymers thereof, and/or any combinations thereof. It is further noted that acrylate monomers are esters that contain vinyl groups directly attached to the carbonyl carbon of the ester group. Acrylate monomers have the structure H₂C═C(R¹)COOR².

Within the context of the present disclosure, the term “tackifier” refers to a material that helps enable the coating to melt when heated. It also helps increase the tensile adhesion and shear strength between two distinct materials, such as between a membrane and the pavement via a bond coat. Examples of tackifiers that are contemplated to be used herein include, but are not limited to, terpene phenolic, styrenated terpene, rosin ester, alpha methyl styrene phenolic, polyterpenes, or any combination thereof. The amount of tackifying resin utilized can be about 10-50% by weight of the composition in which the tackifier is present, preferably about 30% by weight of the composition.

Within the context of the present disclosure, the term “plasticizer” refers to materials that can be added to the bond coat composition to enhance the thermoplastic behavior of the cured material, i.e., allow it to become fully molten when heated above its melting point. Examples of plasticizers that are contemplated to be used herein include, but are not limited to, adipates, dibutyl sebacate, dibutyl maleate, diisobutyl maleate, orthophthalates, terephthalates, dicarboxylic ester phthalates, tricarboxylic ester phthalates, trimellitates, benzoates and others including 1,2-cyclohexane dicarboxylic acid diisononyl ester (DINCH), organophosphates, glycols, polyethers, and bio-based plasticizers. In a preferred embodiment, orthophthalate is used as the plasticizer. The amount of plasticizer utilized can be about 0.1-10% by weight of the composition in which the plasticizer is present, preferably about 2.0-8.0% by weight of the composition, and even more preferably about 3% by weight of the composition.

Within the context of the present disclosure, the term “viscosity” refers to the measure of a fluid's resistance to deformation (flow) at a given shear rate. A liquid with a lower viscosity flows more freely/readily than a liquid with a higher viscosity. Viscosity is typically measured in units of centipoise (cP). The viscosity of a liquid, such as the bond coat composition, may be determined by methods known in the art. It should be noted that embodiments of the current invention can be liquid both before and after cure; both scenarios are defined below. The first scenario embodies the bond coat prior to cure, i.e., before initiator has been added. At this stage, the product is a free-flowing solution of tackifier and other additives dissolved in low viscosity monomers, and free-radical polymerization has yet to be initiated. Addition of radical initiator (e.g., benzoyl peroxide) initiates a free-radical polymerization reaction which leads to the formation of a solid polymer network. The second scenario is when this cured solid material is heated to temperatures above its melting point where it becomes a flowable molten liquid. As can be understood, this second scenario demonstrates thermoplastic behavior as the material melts when heated to temperatures above its melt point; in contrast, thermoset materials do not melt regardless of elevated temperature. Within the context of the present disclosure, viscosity measurements are acquired for this second molten scenario using a cone and plate rheometer (TA INSTRUMENTS HR-1 DISCOVERY Hybrid Rheometer), with a 40-mm parallel plate, 1000-μm gap, and a Peltier plate to control temperature. The temperature is ramped down from 200° C. to 80° C. at a rate of 2° C./minute with 30 viscosity measurements being recorded per minute. The plate is rotated at a shear rate of 1 reciprocal second (1/s). Preferably, at a temperature of about 85° C. or higher, the bond coat taught by the present disclosure has a viscosity of about 6000 cP or lower, 5800 cP or lower, 5600 cP or lower, 5400 cP or lower, 5200 cP or lower, 5000 cP or lower, 4800 cP or lower, 4600 cP or lower, or in a range between any two of these values.

It should be noted that certain embodiments of the current invention have a melting temperature at about 85° C., such that the cured bond coat becomes molten liquid and can interact with the pavement material (e.g., hot asphalt) applied thereon, allowing the pavement material to compact better on the bond coat at the membrane interface resulting in higher surface contact area and hence improved adhesion values. However, this melting point can be tuned according to the composition of the bond coat, such that it may be higher or lower as needed. Thus, the temperature 85° C. is used here as a reference point for embodiments of the current invention. Furthermore, viscosity may also be adjusted based on the composition of the bond coat. A primary consideration is that the molten viscosity of the bond coat be sufficiently low to facilitate excellent compaction of the paving material, providing high surface contact area at the membrane interface resulting in low water penetration (preferably ≤˜50% or even more preferably ≤˜1%) at the interface. The second requirement is for the molten bond coat to fully wet out the paving material and make intimate contact allowing higher adhesion values.

Within the context of the present disclosure, the term “molten liquid” refers to the state of a bond coat having a viscosity sufficiently low to permit interaction with, allow penetration into, wet out and facilitate compaction of a pavement material (e.g., hot asphalt), such that upon solidifying to form a composite where the bond coat and pavement material are secured together, surface contact area at the interface is high, shown by low water penetration (preferably ≤50% or even more preferably ≤1%) at the interface. It can be appreciated that melting point and molten viscosity of the bond coat can vary based on the composition, while still being sufficiently low to permit interaction with, penetration by, and compaction of the pavement material. A sufficient viscosity may be dependent on the nature of the pavement material. For example, certain embodiments of the current invention were found to have a viscosity of about 6000 cP or less measured at 85° C. However, higher viscosities and melting points are contemplated, so long as the cured bond coat can form a molten liquid that interacts with the pavement material, resulting in higher surface contact area and low water penetration at the interface.

It should be noted that when asphalt is used as the pavement material applied onto the bond coat, the maximum temperature that the bond coat will be upon contact with hot asphalt is about 200° C., or more specifically about 190° C. It is thus contemplated that the bond coat should have a melting point below about 200° C., such that when exposed to such temperatures, the bond coat melts, having a suitable viscosity effective to facilitate compaction of a pavement material applied on the bond coat, such that surface contact area at the interface of the bond coat and the pavement material is about 50% or more (resulting in a water penetration of about 50% or less), more preferably about 99% or more (resulting in a water penetration of about 1% or less). In certain embodiments, this exposure temperature is about 100° C. or less and the bond coat viscosity is about 6000 cP or less (though higher viscosity is contemplated).

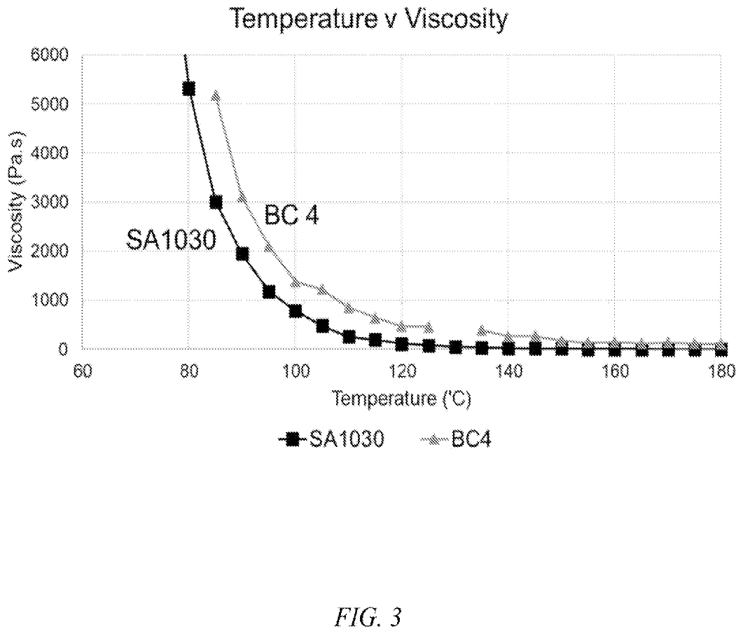

Embodiments of the current bond coat can be seen to exhibit true thermoplastic properties compared to conventional reactive bond coats that do not melt. While conventional reactive bond coats can provide satisfactory performance with bitumen-rich and low-void mix designs, it does not provide suitable performance with asphalt mix designs having higher voids content (>4%), lower bitumen content (<5%) and/or containing larger aggregates (>14 mm). In contrast, the current bond coat has a similar temperature versus viscosity profile to conventional PMB bitumen-based thermoplastic bond coats which are long proven to aid compaction and fill voids at the membrane interface (though the current bond coat does not have the drawbacks of conventional bitumen-based thermoplastic bond coats). See FIG. 3. As also seen in Table 1, the current bond coat is fluid across all temperatures tested, which supports the compaction process. Although the current bond coat is not as fluid as the bitumen-based hot melt thermoplastic bond coat, it is sufficiently fluid to provide excellent compaction, as proven by the lack of water getting to the bond coat-asphalt interface during testing of cured samples, which will be discussed further as this specification continues.

TABLE 1
Viscosity comparisons of a conventional hot-melt
thermoplastic bond coat, a conventional reactive
bond coat, and an embodiment of the current
reactive thermoplastic bond coat.

| | Bond Coat Viscosity (cP) | | |
|---|---|---|---|
| | Conventional | | |
| | hot-melt | Conventional | |
| T | thermoplastic | reactive | Current |
| (° C.) | bond coat | bond coat | bond coat |
| 200 | 2 | Solid* | 158 |
| 190 | 2 | | 114 |
| 180 | 3 | | 108 |
| 170 | 5 | | 134 |
| 160 | 8 | | 156 |
| 150 | 14 | | 179 |
| 140 | 26 | | 269 |
| 120 | 117 | | 470 |
| 115 | 198 | | 640 |
| 110 | 259 | | 854 |
| 105 | 482 | | 1223 |
| 100 | 790 | | 1380 |
| 95 | 1183 | | 2097 |
| 90 | 1949 | | 3115 |
| 85 | 3014 | | 5179 |
| 23 | Solid | Solid | solid |
| | (boiler required | (cold-applied, | (cold-applied, |
| | to melt in order | post-cure) | post-cure) |
| | to apply) | | |

*It should be noted that it is not possible to measure the viscosity of conventional reactive bond coats because they remain predominantly solid at elevated temperatures-only a small fraction (~10%) of their mass actually melts with the majority (~90%) remaining solid.

Within the context of the present disclosure, the term “accelerator” refers to a compound or substance added to one of the components that is a precursor to the combined resin mixture that is sprayed. The accelerator is a co-initiator used in the free radical polymerization of the combined resin mixture. Examples of accelerators that are contemplated to be used herein include, but are not limited to, dimethyl aniline, dimethyl para toluidine, methyl hydroxyethyl para toluidine, and di-isopropyl toluidine. In a preferred embodiment, a toluidine is used as the accelerator. Each of the foregoing accelerators can affect gel/cure times as needed. The amount of accelerator utilized can be about 0-5% by weight of the composition in which the accelerator is present, preferably about 1.5-4% by weight of the composition, and even more preferably about by weight of the composition. In addition to accelerators, an inhibitor may optionally be added to increase storage stability, shelf life and/or working life of the reaction mixture.

Within the context of the present disclosure, the term “radical initiator” refers to a compound or suspension or substance added to one of the components that is a precursor to the resulting bond coat mixture, where it produces radical species and promotes radical reactions upon mixing with other appropriate components. The concentration can be varied depending on the ambient temperature. Examples of radical initiators that are contemplated to be used herein include, but are not limited to, sodium persulphate, potassium persulphate, ammonium persulphate, peroxide initiators, ferrous sulphate and t-butylperoxide, and mixtures thereof. In a preferred embodiment, a peroxide intiator suspension is used as the radical initiator. The amount of radical initiator utilized can be about 0-10% by weight of the composition, preferably about 2-8% by weight, and even more preferably about 3% by weight of the composition.

Methodologically, certain embodiments of the current invention contemplate use of the above-referenced three-component bond coat composition in waterproofing applications, such as on a bridge deck. Components A, B, and C above are packaged individually and transported to the jobsite. On site, Component B is mixed with the Component C to form what will be termed as “activated Component C”. Then an appropriate 1:1 ratio airless spray unit is used to pump Component A and activated Component C via two charging legs towards a mixer unit where Component A and activated Component C are mixed. The mixed material is now fully activated and flows to the spray gun/nozzle, where the material is atomized/sprayed onto the waterproofing membrane (or other substrate) at the desired thickness. The bond coat layer cures via a free-radical polymerization process to provide a solid seamless coating.

On combination of the above-described components, specifically the acrylate-based components, the resulting material is fluid and readily applied onto the substrate (e.g., waterproofing membrane) at the appropriate coat-weight. The accelerator, radical initiator, and acrylate mixture form the basis of the reaction that leads to polymerization. The mixture is sprayed (or otherwise applied) onto the substrate before curing. Once fully cured, and upon application of hot asphalt (≥85° C.), the bond coat melts, allowing the asphalt mix to interact with and penetrate into the molten coating. This facilitates improved compaction and greater surface contact area at the membrane interface. Upon cooling, the bond coat re-solidifies forming a permanent mechanical bond with the asphalt.

In alternative embodiments of the current invention, the bond coat composition is a two-component system, where Component C can be eliminated (or only optionally included), such that the composition comprises and functions with Component A and Component B. Components A and B are packaged individually and transported to the jobsite. On site, Component B is mixed with Component A directly to form a reactive material. The mixture is then immediately applied onto the waterproofing membrane (or other substrate) using a spray pump (1 leg or a 98:2 system) or a manual device, such as a squeegee or roller. The bond coat layer cures via a free-radical polymerization process to provide a solid seamless coating.

More broadly, using a bridge deck as an exemplary application, a base layer or surface of a bridge deck is provided, a primer is applied onto the bridge deck base layer, one or more layers of waterproofing membranes are applied onto the primer, the bond coat composition of certain embodiments of the current invention is applied onto the waterproofing membrane, and pavement is applied onto the bond coat composition.

Within the context of the present disclosure, the term “shear adhesion” refers to a measure of bond strength between two distinct materials, such as between a waterproofing membrane and asphalt, where the bond coat resists shear forces that cause the asphalt to slide off the substrate/membrane. Shear adhesion is typically recorded as units of megapascals (MPa) and may be determined by methods known in the art. Within the context of the present disclosure, shear adhesion measurements are acquired according to ETAG 033 standards, specifically EN13653:2004, unless otherwise stated. Preferably, the bond coat taught by the present disclosure has a shear adhesion—at ˜600-1200 gsm coat weight and ˜23° C. temperature—between about 0.1 MPa and about 3.5 MPa, more preferably between about 0.3 MPa and about 3.0 MPa, or even more preferably between about 0.5 MPa and about 2.5 MPa. Furthermore, the bond coat taught by the present disclosure has a shear adhesion—at ˜600-1200 gsm coat weight and ˜50° C. temperature—between about 0.01 MPa and about 0.5 MPa, more preferably between about 0.03 MPa and about 0.4 MPa, or even more preferably between about 0.05 MPa and about 0.30 MPa. It is contemplated that shear adhesion may be higher than those listed above, based on composition of the asphalt (e.g., if lower Pen/stiffer bitumen is used in the asphalt mix design).

Within the context of the present disclosure, the term “tensile adhesion” refers to a measure of bond strength between two distinct materials, more specifically between waterproofing membrane and asphalt, where the bond coat adheres the materials upon applying a perpendicular tensile force. Tensile adhesion is typically recorded as units of megapascals (MPa) and may be determined by methods known in the art. Within the context of the present disclosure, tensile adhesion measurements are acquired according to ETAG 033 standards, specifically EN16596, unless otherwise stated. Preferably, the bond coat taught by the present disclosure has a tensile adhesion—at ˜600-1200 gsm coat weight and ˜23° C. temperature—between about 0.1 MPa and about 1.5 MPa, more preferably between about 0.3 MPa and about 1.3 MPa, or even more preferably between about 0.5 MPa and about 1.0 MPa. Furthermore, the bond coat taught by the present disclosure has a tensile adhesion—at ˜600-1200 gsm coat weight and ˜50° C. temperature—between about 0.01 MPa and about 0.35 MPa, more preferably between about 0.04 MPa and about 0.30 MPa, or even more preferably between about 0.07 MPa and about 0.25 MPa. It is contemplated that tensile adhesion may be higher than those listed above, based on composition of the asphalt (e.g., if lower Pen/stiffer bitumen is used in the asphalt mix design).

It should be noted that although the current composition and method are typically most beneficial for adhesion between a waterproofing membrane and various types of asphalt in bridge deck applications, other suitable pavement materials and applications are contemplated herein as well. Referring specifically to asphalt, certain embodiments of the current bond coat can be designed for various types of asphalt, including, but not limited to, asphaltic concrete (AC), hot rolled asphalt (HRA), stone mastic asphalt (SMA), mastic asphalt (MA), porous asphalt, and sand carpet (e.g., asphalt protection layer). It should be noted that even within each category of asphalt, there is no fixed mix design, and a large variation can be observed in the thickness of the asphalt and the asphalt composition.

An exemplary embodiment of the current invention is a low-VOC, 100% solids, reactive, cold-applied liquid coating system. The coating is able to fully cure within two (2) hours, and preferably one (1) hour, within a wide temperature range (about −10° C. to +50° C.). These properties minimize process application times across a wide application temperature range. Certain embodiments of the current invention are unique in that they are cold-applied reactive materials, yet behave as thermoplastic materials. This feature provides significant utility as there is no longer a need for hot boilers to melt traditional thermoplastic materials (such as bitumen), yet the material maintains thermoplastic properties upon curing. The exemplary embodiment of the current coating is a cold applied liquid, offering many advantages including lower energy costs, carbon emissions, fumes into the environment, and better bond to the substrate/membrane.

Within the context of the present disclosure, the term “cure time” refers to the time required for the fully initiated composition to solidify with a tack free surface. Cure time is recorded in any unit of time, such as seconds, minutes, or hours. Within the context of the present disclosure, unless otherwise stated, cure time is acquired according to ASTM D5895 standards and/or otherwise recorded when the material is dry to physical touch. Preferably, the reactive thermoplastic bond coat composition taught by the present disclosure has a cure time of about 3.0 hours or less, about 2.5 hours or less, about 2.0 hours or less, about 1.5 hours or less, about 1.0 hours or less, or in a range between any two of these values. More preferably, the cure time of the bond coat is about 2.0 hours or less and more specifically about 1.0 hours or less, in a temperature range of about −10 to +50° C. A lowest end of the range is contemplated to be about 1 minute, though this is dependent upon the ambient temperature and the radical initiator concentration within the composition itself.

In further embodiments, the current formulation allows the fully-cured material to heat-activate/melt when asphalt of any type is applied on to it ˜85° C. or higher. Its thermoplastic properties—when heat-activated—match the performance of conventional hot-melt PMB thermoplastic bond coats. It is noted that these conventional hot-melt PMB thermoplastic bond coats are heat-applied, e.g., boilers are required for melting for application and poor bond is observed to the membrane-drawbacks that are alleviated using certain embodiments of the current invention.

In certain embodiments, the current bond coat can be spray-applied at various coat weights (e.g., about 200, 300, 600, 1200, and/or 1400 gsm) depending on the application requirements. Within the context of the present disclosure, the term “coat weight” or “wet film thickness” refers to a measure of the amount of a coating, such as a bond coat, on a substrate, such as a waterproofing membrane. Coat weight is typically recorded as units of grams per square meter (gsm). The coat weight of a material may be determined by methods known in the art. Within the context of the present disclosure, unless otherwise stated, coat weight measurements are acquired using a dip comb (ELCOMETER 112AL) as the material is sprayed and remains liquid on the substrate (e.g., bridge deck) prior to curing. The dip comb is pressed on to the liquid bond coat before it cures, and this provides the applicator with a thickness measurement. The wet film thickness correlates to the gsm by using the density as a conversion factor. Preferably, the bond coat taught by the present disclosure can be applied at a coat weight of about 50 gsm or more, 100 gsm or more, 300 gsm or more, 600 gsm or more, 900 gsm or more, 1200 gsm or more, 1500 gsm or more, 1800 gsm or more, 2100 gsm or more, or in a range between any two of these values. An upper range of this coat weight measurement can be about 2500 gsm, though bond coat thickness will ultimately be dependent on the asphalt mix design and asphalt thickness.

It should be noted that conventional bitumen-based emulsions are applied using heated lines and squeegees, resulting in inconsistent thicknesses due to difficulty in control. Conventional PMB thermoplastic bond coats are also difficult to apply, as they are typically spread by applicators using squeegees; this application method not only results in inconsistent thicknesses, similar to bitumen-based emulsions, but also must be completed very quickly due to a relatively small time window when the bitumen is extremely hot and thus fluid. If the conventional bitumen thermoplastic bond coat is applied too thick, “bleeding” can occur. When hot asphalt is applied to the bond coat, the thicker areas can melt and “bleed” into the actual asphalt paving. This leaves little bond coat at the interface, in turn creating voids. This is a particular problem for applications taking place at high temperatures, when the conventional PMB thermoplastic bond coats are softest. This bleeding can be seen when doing a shear adhesion test, according to the ETAG 033 standard at 60° C. A shear test according to this standard also shows slippage of the asphalt layer when using thick hot melt PMBs at high temperatures—sometimes referred to as “fatigue”. Conventional PMB thermoplastic bond coats are prone to peeling off the membrane at high temperatures when trafficked, creating a significant issue for contractors as trafficking is an essential requirement on a busy construction site. In contrast, certain embodiments of the current invention have demonstrated a well-adhered bond to the membrane even at high temperatures, thus eliminating any pick-up or peeling issues. This characteristic was seen when performing the ETAG 033 tensile adhesion test from about 10° C. to about 50° C. Significantly lower adhesion values were observed for conventional PMB thermoplastic bond coats compared to the current bond coat.

In terms of adhesion performance, certain embodiments of the current bond coat provide excellent adhesion characteristics with asphalt pavements. Conventional systems, such as bitumen-based emulsions and bitumen thermoplastic materials, provide lower adhesive properties at high temperatures (30-60° C.) due to their lower softening points. In contrast, the bond coat described herein does not soften until it is activated and therefore produces improved adhesion results. It should be noted that adhesion values can be lower than expected when the asphalt pavement itself is the weakest point in the composite system.

Another advantage of certain embodiments of the current invention over other reactive systems and bitumen emulsions is that they provide a fluid base for the hot asphalt pavement, allowing for great compaction. This advantage also applies to asphalt pavement mix designs that have high void content, low bitumen content (high aggregate content), and large aggregate size. Furthermore, the increased compaction of asphalt reduces the asphalt pavement thickness requirement, thus reducing cost and labor. Compaction of asphalt is important as it reduces interconnecting voids at the interface and subsequent accumulation of water at the interface (see FIGS. 2-3). It is very well-known in the industry that interconnecting voids and water accumulation should be avoided. See J C Nicholls, et al., “Asphalt Surfacing to Bridge Decks”, TRL Report TRL655 (2006). The importance of reducing interconnecting voids is also highlighted in the Highways England Design Manual for Roads and Bridges (Document CD358, Sections 6.4, 8.8, 8.8.1).

Within the context of the present disclosure, the term “average aggregate size” refers to a length measurement approximately across the diameter of individual particles within a group. Within the context of the present disclosure, average aggregate size is acquired according to BS EN 12697 (Part 1, Part 2, Part 35) standards, unless otherwise stated. Preferably, the asphalt that is applied onto the bond coat composition taught by the present disclosure has an average aggregate size of about 1 mm or more, mm or more, about 15 mm or more, about 25 mm or more, about 35 mm or more, about 45 mm or more, about 55 mm or more, or in a range between any two of these values. More preferably, the average aggregate size of the asphalt up to about 40 mm and more specifically up to about 35 mm. An upper end of the range is contemplated to be about 55 mm, though this is dependent upon the asphalt composition.

As indicated previously, additives may be added at certain points during the foregoing formulating process. Within the context of the present disclosure, the term “additive” refers to optional materials that can be added to the bond coat composition. Additives can be added to alter or improve desirable properties in the bond coat composition, or to counteract undesirable properties therein. Examples of additives includes, but are not limited to, fillers, inhibitors, pigments, anti-settlement aids, rheology modifiers, photoinitiators, UV stabilizers, degassers, antistatic agents, accelerants, catalysts, stabilizers, fire retardants, pH adjusters, reinforcing agents, thickening or thinning agents, elastic compounds, chain transfer agents, radiation absorbing or reflecting compounds, and other additives known in the art. The amount of additive utilized can be about 0-50% by weight of the composition in which the additive is present.

### EXAMPLES/EXPERIMENTS

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by weight of the total bond coat composition, unless otherwise specified.

### Example 1

A thermoplastic bond coat was prepared according to the following formulation:
(1) Component A
   a. PMMA polymer in an amount of about 10-30% by weight of the composition, wherein the PMMA polymer is composed of one or more acrylate monomers having the structure H₂C═C(R¹)COOR², and wherein one or more PMMA polymers may be used in the formulation;
   b. Acrylate monomers in an amount of about 5-45% by weight of the composition, where the acrylate monomers have the structure H₂C═C(R¹)COOR²;
   c. Tackifier in an amount of about 10-50% by weight of the composition, where the Tackifier comprises a terpene phenolic, styrenated terpene, rosin ester, alpha methyl styrene phenolic, polyterpenes, or combination thereof;
   d. Plasticizer in an amount of about 0.1-10% by weight of the composition, examples including adipates, dibutyl sebacate, dibutyl maleate, diisobutyl maleate, orthophthalates, terephthalates, dicarboxylic ester phthalates, tricarboxylic ester phthalates, trimellitates, benzoates and others including 1,2-cyclohexane dicarboxylic acid diisononyl ester (DINCH), organophosphates, glycols, polyethers, and bio-based plasticizers;
   e. Optionally at least one additive in an amount of about 0-50% by weight of the composition, examples including fillers, inhibitors, pigments, waxes, anti-settlement aids, and rheology modifiers, among other suitable additives to achieve certain objectives; and f. An accelerator in an amount of about 0-5% by weight of the composition such as dimethyl aniline, dimethyl para toluidine, methyl hydroxyethyl para toluidine or di-isopropyl toluidine.
(2) Component B
   a. Peroxide initiator suspension in an amount of up to about 10% by weight of the composition.
(3) Component C
   a. PMMA polymer in an amount of about 10-30% by weight of the composition, wherein the PMMA polymer is composed of one or more acrylate monomers having the structure H₂C═C(R¹)COOR², and wherein one or more PMMA polymers may be used in the formulation;
   b. acrylate monomers in an amount of about 5-45% by weight of the composition, where the acrylate monomers have the structure H₂C═C(R¹)COOR²;
   c. Tackifier in an amount of about 10-50% by weight of the composition, where the Tackifier comprises a terpene phenolic, styrenated terpene, rosin ester, alpha methyl styrene phenolic, polyterpenes, or combination thereof;
   d. Plasticizer in an amount of about 0.1-10% by weight of the composition, examples including adipates, dibutyl sebacate, dibutyl maleate, diisobutyl maleate, orthophthalates, terephthalates, dicarboxylic ester phthalates, tricarboxylic ester phthalates, trimellitates, benzoates and others including 1,2-cyclohexane dicarboxylic acid diisononyl ester (DINCH), organophosphates, glycols, polyethers, and bio-based plasticizers; and
   e. Optionally at least one additive in an amount of about 0-50% by weight of the composition, examples including fillers, inhibitors, pigments, waxes, anti-settlement aids, and rheology modifiers, among other suitable additives to achieve certain objectives.

Component C was activated with Component B and placed under the pump leg. Component A was placed under the adjacent leg and the combined material was spray-applied onto the waterproofing membrane, which was pre-applied on a primed concrete substrate.

Two samples were prepared by spraying the prepared coating to two depths (coat weights) of about 600 gsm and about 1200 gsm, respectively. The coating had a cure time within one (1) hour at 23° C. to provide a solid, smooth, and seamless finish. The resulting composite material was then placed into a mold chamber in which hot asphalt (160° C.) was compacted on top of the bond coat to a thickness of about 50 mm. In this example, an AC10 type asphalt was used; this type of asphalt contains an average aggregate size of about 10 mm and has a tendency to generate a large amount of interconnecting voids. Upon completion of compaction, the asphalt was cooled with water.

The resulting material was cut to the appropriate test piece size and samples were prepared for tensile and shear adhesion testing according to ETAG 033 standards (EN16596 and EN13653:2004, respectively). The test results are shown in Table 2 below for samples tested at 23° C. and 50° C.:

TABLE 2
Shear and tensile adhesion of samples having 600-and
1200-gsm bond coat thicknesses at 23° C. and 50° C.
As can be seen, the results meet the minimum requirements
found in UK national standards, such as CD358
(waterproofing and surfacing of concrete bridge decks).
AC10 asphalt (160° C.)

| Coat weight (gsm) | 600 | 1200 |
|---|---|---|
| Shear @ 23° C. (MPa) | 0.61 | 0.86 |
| Shear @ 50° C. (MPa) | 0.06 | 0.15 |
| Tensile @ 23° C. (MPa) | 0.51 | 0.78 |
| Tensile @ 50° C. (MPa) | 0.08 | 0.15 |

Significant compaction of the asphalt was also observed at the interface between the bond coat and the pavement surfacing—a result of using the current bond coat which melts upon contact with the hot asphalt. The molten layer assists in better compaction at the interface, which results in more surface contact area between asphalt and bond coat, which in turn results in greater adhesion. Furthermore, the current bond coat allows aggregate from the asphalt to penetrate into and embed in it creating a strong mechanical bond. At the same time, the molten bond is displaced upwards to fill any remaining voids at the interface. The improved surface contact area was proven by analyzing how much water penetrated the asphalt and reached the bond coat interface. As reference, a higher amount of water penetrating the asphalt indicates a lack of asphalt compaction due to larger voids at the interface and passageways among the asphalt particles. A lower amount of water penetrating the asphalt to the interface indicates good asphalt compaction at the interface due to small or non-existent voids and passageways among the asphalt particles at the interface. It was found that with this composite system including the exemplary bond coat, less than 1% water migrated to the bond coat interface. This system provides a more robust waterproofing system compared to conventional systems (excluding PMBs) where limited compaction occurs at the interface.

### Example 2

A thermoplastic bond coat was prepared according to the formulation of Example 1. Two samples were prepared by spraying the prepared coating to two depths (coat weights) of about 600 gsm and about 1200 gsm, respectively. The coating had a cure time within one (1) hour at 23° C. to provide a solid, smooth and, seamless finish. The resulting composite material was then placed into a mold chamber in which hot asphalt (˜160° C.) was compacted on top of the bond coat to a thickness of about 50 mm. In this example, an AC32 type asphalt was used; this type of asphalt contains an average aggregate size of about 32 mm and has a tendency to generate a large amount of interconnecting voids. Upon completion of compaction, the asphalt was cooled with water.

The resulting material was cut to the appropriate test piece size and samples were prepared for tensile and shear adhesion testing according to ETAG 033 standards (EN16596 and EN13653:2004). The test results are shown in Table 3 below for samples tested at 23° C. and 50° C.:

TABLE 3
Shear and tensile adhesion of samples having 600-and
1200-gsm bond coat thicknesses at 23° C. and 50° C.
As can be seen, the results meet the minimum requirements
found in UK national standards, such as CD358
(waterproofing and surfacing of concrete bridge decks).
AC32 asphalt (160° C.)

| Coat weight (gsm) | 600 | 1200 |
|---|---|---|
| Shear @ 23° C. (MPa) | 1.14 | 2.43 |
| Shear @ 50° C. (MPa) | 0.16 | 0.28 |
| Tensile @ 23° C. (MPa) | 0.77 | 0.83 |
| Tensile @ 50° C. (MPa) | 0.19 | 0.24 |

The foregoing examples and embodiments were present for illustrative purposes only and not intended to limit the scope of the invention.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A reactive cold-applied thermoplastic bond coat system, comprising:
a first component comprising:
a polyacrylate polymer, preferably in an amount of about 10-30% by weight of the composition,
acrylate monomers, preferably in an amount of about 5-45% by weight of the composition,
a tackifier, preferably in an amount of about 10-50% by weight of the composition,
a plasticizer, preferably in an amount of about 0.1-10% by weight of the composition, and
an accelerator, preferably in an amount of about 0-5% by weight of the composition; and
a second component comprising an initiator suspension, such as a peroxide initiator suspension, in an amount of about 0-10% by weight of the composition,
wherein a mixture of the first component and the second component is sprayable or manually applicable and cures to form a solid bond coat.

2. The bond coat system of claim 1, wherein the polyacrylate polymer of the first component is a polymethacrylate polymer, a poly(methyl methacrylate) polymer, homopolymers thereof, copolymers thereof, or combinations thereof.

3. The bond coat system of claim 1, wherein the first component further comprises at least one additive, preferably in an amount of about 0-50% by weight of the composition.

4. The bond coat system of claim 3, wherein the at least one additive is selected from fillers, inhibitors, pigments, anti-settlement aids, rheology modifiers, photoinitiators, UV stabilizers, degassers, antistatic agents, accelerants, catalysts, stabilizers, fire retardants, pH adjusters, reinforcing agents, thickening or thinning agents, elastic compounds, chain transfer agents, radiation absorbing compounds, radiation reflecting compounds, and combinations thereof.

5. The bond coat system of claim 1, further comprising a third component comprising:
a polyacrylate polymer, preferably in an amount of about 10-30% by weight of the composition;
acrylate monomers, preferably in an amount of about 5-45% by weight of the composition;
a tackifier, preferably in an amount of about 10-50% by weight of the composition; and
a plasticizer, preferably in an amount of about 0.1-10% by weight of the composition,
wherein
a mixture of the second component and the third component forms an activated third component, and
a mixture of the first component and the activated third component is sprayable and cures to form the bond coating.

6. The bond coat system of claim 5, wherein the polyacrylate polymer of the third component is a polymethacrylate polymer, a poly(methyl methacrylate) polymer, homopolymers thereof, copolymers thereof, or combinations thereof.

7. The bond coat system of claim 5, wherein the third component further comprises at least one additive, preferably in an amount of about 0-50% by weight of the composition.

8. The bond coat system of claim 7, wherein the at least one additive is selected from fillers, inhibitors, pigments, anti-settlement aids, rheology modifiers, photoinitiators, UV stabilizers, degassers, antistatic agents, accelerants, catalysts, stabilizers, fire retardants, pH adjusters, reinforcing agents, thickening or thinning agents, elastic compounds, chain transfer agents, radiation absorbing compounds, radiation reflecting compounds, and combinations thereof.

9. The bond coat system of claim 1, wherein the bond coat, after curing and upon exposure to a temperature of about 200° C. or below, becomes a molten liquid having a viscosity effective to permit compaction of a pavement material applied on the bond coat and increase the surface contact area, such that a water penetration at the interface of the bond coat and the pavement material is about 50% or less, preferably about 1% or less.

10. The bond coat system of claim 9, wherein the temperature is about 100° C. or less and the viscosity is about 6,000 cP or less.

11. The bond coat system of claim 1, wherein a shear adhesion between a substrate on which the bond coat is applied and a pavement material applied on the bond coat is between about 0.3 MPa and about 3.0 MPa at a temperature of about 23° C. and a coat weight of about 600-1200 gsm.

12. The bond coat system of claim 1, wherein a tensile adhesion between a substrate on which the bond coat is applied and a pavement material applied on the bond coat is between about 0.3 MPa and about 1.3 MPa at a temperature of about 23° C. and a coat weight of about 600-1200 gsm.

13. A method of binding a pavement material to a substrate, comprising:
mixing together a first component and a second component;
wherein the first component comprises:
a polyacrylate polymer, preferably in an amount of about 10-30% by weight of the composition,
acrylate monomers, preferably in an amount of about 5-45% by weight of the composition,
a tackifier, preferably in an amount of about 10-50% by weight of the composition,
a plasticizer, preferably in an amount of about 0.1-10% by weight of the composition, and
an accelerator, preferably in an amount of about 0-5% by weight of the composition;
wherein the second component comprises an initiator suspension, such as a peroxide initiator suspension, in an amount of about 0-10% by weight of the composition;
applying the mixture onto the substrate without the use of heating elements;
allowing the mixture to cure to form a cured bond coat;
applying the pavement material onto the cured bond coat to form a composite of the cured bond coat and the pavement material, where the composite binds the pavement material to the substrate and provides for a waterproof bond between the pavement material and the substrate.

14. The method of claim 13, wherein the pavement material comprises asphalt.

15. The method of claim 14, wherein the asphalt is selected from the group consisting of asphaltic concrete, hot rolled asphalt, stone mastic asphalt, mastic asphalt, porous asphalt, sand carpet, and asphalt protection layer.

16. The method of claim 14, wherein the asphalt has an average aggregate size up to about 55 mm.

17. The method of claim 13, wherein the substrate comprises a waterproofing membrane.

18. The method of claim 13, wherein the step of applying the mixture onto the substrate is performed by spraying the mixture onto the substrate.

19. The method of claim 13, wherein the mixture is applied onto the substrate at a coat weight of about 100 gsm to about 1400 gsm.

20. The method of claim 13, further comprising mixing a third component together with the second component to form an activated third component, which is subsequently mixed with the first component and applied onto the substrate.

21. The method of claim 13, wherein upon application of the pavement material onto the cured bond coat, the pavement material is capable of compacting on the bond coat, such that a water penetration at the interface of the bond coat and the pavement material is about 50% or less, preferably about 1% or less.

22. The method of claim 13, wherein the bond coat, after curing and upon exposure to a temperature of about 200° C. or below, becomes a molten liquid having a viscosity effective to permit compaction of a pavement material applied on the bond coat and increase the surface contact area, such that a water penetration at the interface of the bond coat and the pavement material is about 50% or less, preferably about 1% or less.

23. The method of claim 22, wherein the temperature is about 100° C. or less and the viscosity is about 6,000 cP or less.

24. The method of claim 13, wherein a shear adhesion between the substrate and a pavement material applied on the bond coat is between about 0.3 MPa and about 3.0 MPa at a temperature of about 23° C. and a coat weight of about 600-1200 gsm.

25. The method of claim 13, wherein a tensile adhesion between the substrate and a pavement material applied on the bond coat is between about 0.3 MPa and about 1.3 MPa at a temperature of about 23° C. and a coat weight of about 600-1200 gsm.

26. A package or kit comprising:
a first component comprising:
a polyacrylate polymer, preferably in an amount of about 10-30% by weight of the composition,
acrylate monomers, preferably in an amount of about 5-45% by weight of the composition,
a tackifier, preferably in an amount of about 10-50% by weight of the composition,
a plasticizer, preferably in an amount of about 0.1-10% by weight of the composition, and
an accelerator, preferably in an amount of about 0-5% by weight of the composition; and
a second component comprising an initiator suspension, such as a peroxide initiator suspension, in an amount of about 0-10% by weight of the composition,
an optional third component comprising:
a polyacrylate polymer, preferably in an amount of about 10-30% by weight of the composition;
acrylate monomers, preferably in an amount of about 5-45% by weight of the composition;
a tackifier, preferably in an amount of about 10-50% by weight of the composition; and
a plasticizer, preferably in an amount of about 0.1-10% by weight of the composition,
wherein a mixture of the first component and the second component is sprayable or manually applicable and cures to form a solid bond coat, or
if the optional third component is present, wherein
a mixture of the second component and the third component forms an activated third component, and
a mixture of the first component and the activated third component is sprayable and cures to form the bond coating.

27. A method of binding a pavement material to a substrate using the package or kit of claim 26, comprising:
transporting the first component, the second component, and the optional third component to a jobsite;
mixing the first component, the second component, and the optional third component at the jobsite;
applying (e.g., spraying) the mixture onto the substrate without the use of heating elements;
allowing the mixture to cure to form a cured bond coat;
applying the pavement material onto the cured bond coat to form a composite of the cured bond coat and the pavement material, where the composite binds the pavement material to the substrate and provides for a waterproof bond between the pavement material and the substrate.
